(19) United States
(12) Patent Application Publication
(10) Pub. No.: US 2023/0217934 A1
(43) Pub. Date: Jul. 13, 2023

(54) Dividable Dough Sheet Piece

(71) Applicant: General Mills, Inc., Minneapolis, MN (US)

(72) Inventors: Craig E. Gustafson, Bloomington, MN (US); Roberta Marie Langenfeld, Minnetonka, MN (US); Todd A. Rasmussen, Scandia, MN (US); Bruce W. Robb, St. Louis Park, MN (US); Dalton Sherrill, Loretto, MN (US); Michael Snyder, Stacy, MN (US); Andrew Friend Souder, Joplin, MO (US); Kiara C. Camareno Vargas, Minneapolis, MN (US)

(73) Assignee: General Mills, Inc., Minneapolis, MN (US)

(21) Appl. No.: 17/572,778

(22) Filed: Jan. 11, 2022

(51) Int. Cl. A21C 11/12; A21C 11/04; A21C 11/08; A21C 3/10

(52) U.S. Cl. CPC A21C 11/12; A21C 11/04; A21C 11/08; A21C 3/10

(57) ABSTRACT

A dividable dough sheet piece gives consumers enhanced flexibility in creating food items from pre-made sheeted dough. The dividable dough sheet piece is cut from a dough sheet, with the dividable dough sheet piece having a perimeter and including a plurality of interconnected, sub-pieces defined within the perimeter. Each sub-piece is defined by one or more lines of structural weakness that provide predetermined breaking points. The dividable dough sheet piece can be used as a whole or can be divided into the sub-pieces for alternative use.

### BACKGROUND OF THE INVENTION

The invention pertains to the art of food and, more particularly, to sheeted dough products and to their apparatus for and methods of production.

Due to the time demands placed on consumers by the everyday activities of modern life, the preparation of food products from scratch has decreased and the popularity of premade or partially premade foods has increased dramatically. Such products include pre-made dough in sheeted form that is ready-to-bake (or that is frozen and just needs to be thawed before baking). Examples of pre-made dough sheets include pie crust dough sheets, pizza crust dough sheets and crescent roll dough sheets. Typically, sheets of dough are formed (e.g., between rollers) and usually undergo further processing (e.g., cutting) before they are packaged and refrigerated or frozen. In the case of pre-made pie crust dough sheets, oval or circular pieces are typically cut from a sheet of pie dough and sized so as to fit in conventional pie pans and the oval or circular pieces are rolled up and packaged. Similarly, in the case of pre-made pizza dough sheets, circular or rectangular pieces are cut and sized to fit conventional baking sheets and the pieces are rolled up and packaged. However, consumers may desire to make unconventionally sized and/or shaped foods using pre-made dough (e.g., mini-pies or mini-pizzas).

### SUMMARY OF THE INVENTION

The present invention provides a product, and a method and an apparatus for making a product, that gives consumers enhanced flexibility in creating food items from pre-made sheeted dough. In particular, the present invention provides a readily dividable dough sheet piece and a method and apparatus for making such a dividable dough sheet piece. More specifically, a dough sheet piece cut from a dough sheet is defined by a perimeter and has a plurality of sub-pieces defined within the perimeter. Each sub-piece of the dividable dough sheet piece is defined by one or more lines of structural weakness. The lines of structural weakness provide predetermined breaking or separation points within the dividable dough sheet piece. As such, the dividable dough sheet piece can be used as a whole or can be divided (via the lines of structural weakness) into the pre-defined sub-pieces for alternative use.

The dividable dough sheet piece is preferably cut from a dough sheet and made from a dough suitable for making a pie crust or a pizza crust. However, other doughs, such as doughs for other refrigerated or frozen sheeted dough products, can be used to form the dividable dough sheet piece. Preferably, the perimeter of the dividable dough sheet piece defines an oval or circle. However, other shapes can be defined by the perimeter in accordance with the present invention (e.g., various polygon shapes). The lines of structural weakness in the dividable dough sheet piece can define a various number of sub-pieces (e.g., seven) and can define sub-pieces of various shapes (e.g., a hexagon or other polygonal shape). The lines of structural weakness can be score lines and/or include perforations. Dough trimmings can exist external to the defined sub-pieces of the dividable dough sheet piece and can be repurposed (e.g., reshaped as decorative topping) by the consumer after the sub-pieces are separated therefrom.

In some embodiments, the dividable dough sheet piece is made from dough suitable for making pie crust. A pie crust can be prepared by placing the dough sheet piece as a whole (i.e., with its sub-pieces and any trimmings intact) into a pie pan. Alternatively, the sub-pieces of the dough sheet piece can be separated therefrom along their respective lines of weakness and individually placed into cups of a muffin tin to prepare mini-pie crusts.

In other embodiments, the dividable dough sheet piece is made of dough suitable for making pizza crust. The intact dough sheet piece can be used to prepare a pizza crust or the sub-pieces thereof can be separated and used to prepare mini-pizza crusts.

In one embodiment, the dividable dough sheet piece is made from a dough sheet which is transported by a conveyor system and passes beneath a rotary cutter configured to repeatedly cut dough pieces from the dough sheet. Preferably, each full rotation of the rotary cutter results in one dough sheet piece being cut from the dough sheet. The rotary cutter includes a shaft and a plurality of blades extending radially outward from the shaft and being curved around the circumference of the shaft. An outer blade defines and encloses an interior area and inner blades are located in the interior area. The outer blade is configured to cut individual dividable dough sheet pieces from the dough sheet (i.e., cut to form the outer perimeter of each dividable dough sheet piece). Each of the inner blades includes a plurality of teeth configured to create the lines of structural weakness within the dividable dough sheet piece. Preferably, the teeth score (to form score lines) or perforate the dough sheet piece to create the lines of structural weakness at the same time the dough sheet piece is being cut from the dough sheet by the outer blade. The inner blades of the rotary cutter are arranged to form the number (e.g., seven) and shapes (e.g., hexagon) of the sub-pieces of the dividable dough piece. In other embodiments, multiple cutter devices are spaced along the conveyor to sequentially perform the functions of the inner and outer blades.

Additional objects, features and advantages of the invention will become readily apparent from the following description of preferred embodiments of the invention when taken in conjunction with the drawings wherein like reference numerals refer to corresponding structure in the various views.

### BRIEF DESCRIPTION OF THE DRAWINGS

FIG. 1 is a top view of a dividable dough sheet piece having sub-pieces defined by lines of structural weakness in accordance with the invention.

FIG. 2 is a perspective view of a dividable dough sheet piece in accordance with the invention placed within a pie pan and crimped along its perimeter.

FIG. 3 is a perspective view of sub-pieces of the dividable dough sheet piece in accordance with the invention placed within cups of a muffin pan.

FIG. 4 is a perspective view of a portion of a production line for producing dividable dough sheet pieces in accordance with the invention.

FIG. 5 is a perspective view of a rotary cutter constructed in accordance with the invention.

FIG. 6 is a side view of the rotary cutter of FIG. 5.

FIG. 7 is a top view of the rotary cutter of FIG. 5.

FIG. 8 is a perspective view of a portion of an alternative production line.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention. In addition, any numerical value listed herein modified by the word “about” includes a margin of error of +/−10%. Additionally, as used in connection with the present invention, terms such as “perpendicular” do not necessarily require, for example, that the relevant items be perfectly parallel. Instead, these terms include a margin of error of +/−5° (regardless of whether the error is by design or due to inherent manufacturing limitations) so long as the error does not prevent the present invention from functioning as intended. The modifier “substantially” increases the margin of error to +/−10°.

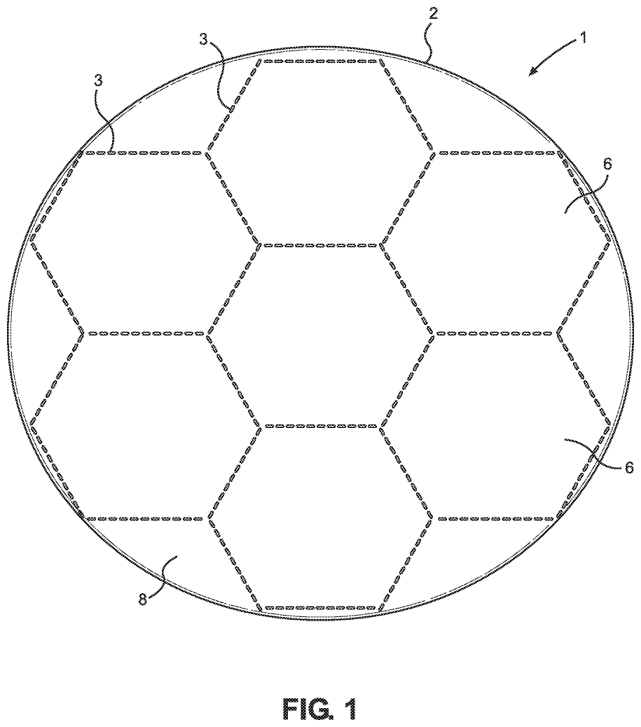

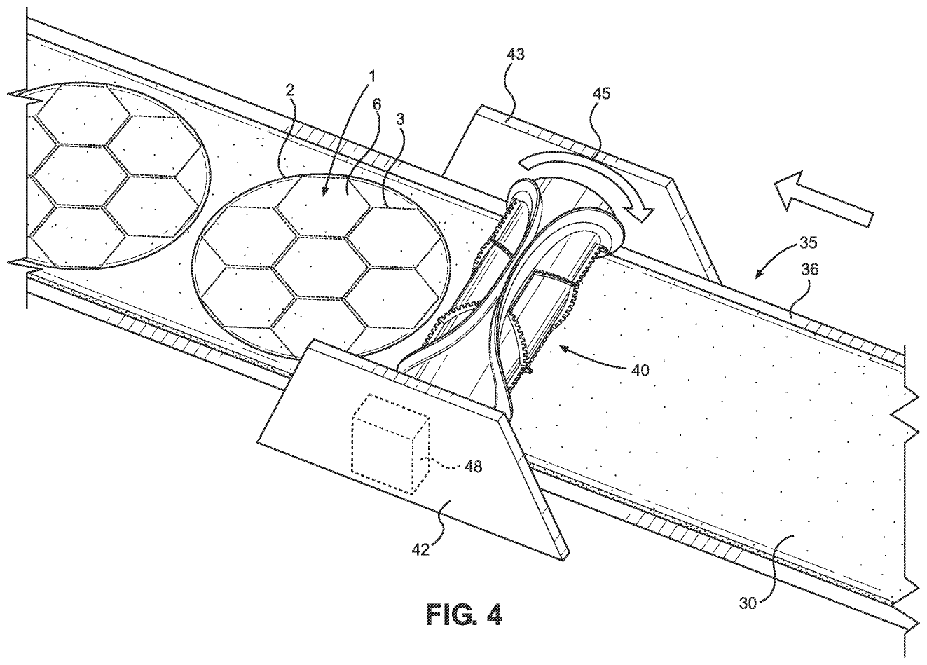

With initial reference to FIG. 1, there is shown a dividable dough sheet piece 1 having a perimeter 2. As shown, perimeter 2 actually defines an oval shape. However, other shapes can be defined by the perimeter in accordance with the present invention (e.g., a circle). Preferably, dividable dough sheet piece 1 is cut from a dough sheet, as described further below specifically with reference to FIG. 4. Dividable dough sheet piece 1 is preferably made from a known dough suitable for making a pie crust or a pizza crust. However, other doughs, such as doughs for other refrigerated or frozen sheeted dough products, can be used to form dividable dough sheet piece 1. Preferably, the dough is made using wheat flour. However, the dough can be made using various types of flour (e.g., gluten-free flour) or combination of flours, as desired.

In accordance with the invention, dividable dough sheet piece 1 has lines of structural weakness 3 that define a plurality of sub-pieces 6. In the embodiment shown in FIG. 1, there are seven sub-pieces 6, each of which are generally hexagonally shaped, being defined by six lines of structural weakness 3. However, other, preferably polygonal shapes can be defined and the number of sub-pieces can be other than seven in accordance with the present invention. Preferably, each sub-piece 6 is a polygon and the plurality of sub-pieces 6 are tessellated to minimize gaps therebetween. Also, preferably the plurality of sub-pieces 6 comprises at least 40% of dough sheet piece 1, more preferably at least 50% and, most preferably more than 70% of dough sheet piece 1.

Lines of structural weakness 3 provide pre-determined breaking points within dough sheet piece 1 that are optionally employed by a consumer to separate sub-pieces 6 from a remainder of dough sheet piece 1 as discussed further below. Lines of structural weakness 3 can be score lines and/or include perforations. Score lines are cuts in the surface of the dough sheet piece and do not extend completely through the dough sheet piece. Score lines may be continuous or broken (i.e., a series of disconnected cut segments). Contrasted with score lines, perforations extend through the dough sheet piece. If a line of structural weakness 3 includes perforations, the perforations may be a series of spaced perforations with certain perforation lines being common to multiple sub-pieces 6 as shown in FIG. 1 or a series of disconnected perforations that create a web of dough between sub-pieces 6. In any case, the lines of structural weakness 3 facilitate the selective separation of sub-pieces 6 from dough sheet 1.

In the embodiment shown in FIG. 1, there are also trimmings 8, which are external to sub-pieces 6 and which remain when sub-pieces 6 are separated from dough sheet piece 1. After separation from dough sheet piece 1, trimmings 8 can be reshaped and used by a consumer, e.g., as a decorative topping. In other embodiments and depending on the shapes and/or sizes of dough sheet piece 1 and sub-pieces 6, and the design of the cutter employed to make lines 3, there may be little or no trimmings 8. For example, as shown in FIG. 1, there are no trimmings 8 between common adjacent walls of the sub-pieces 6 but, in other embodiments, there may be trimmings 8 directly between inner adjacent walls of the sub-pieces 6.

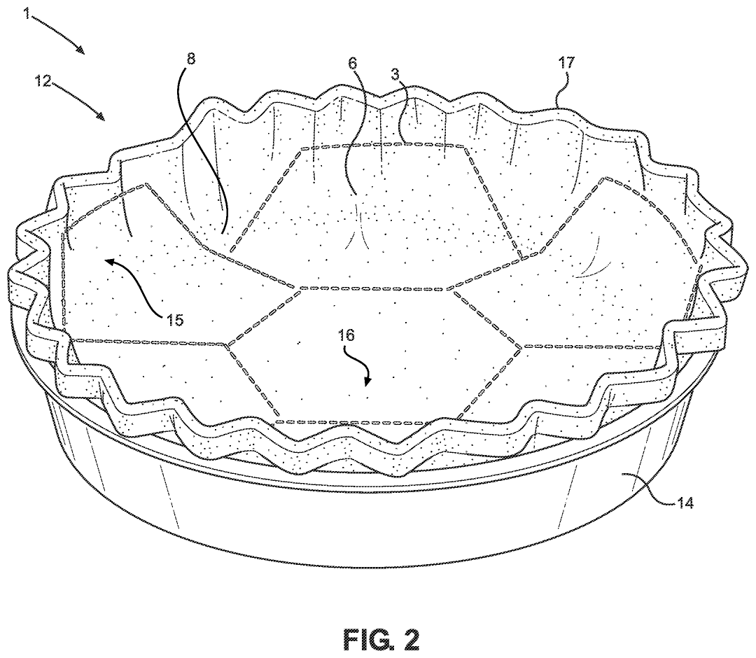

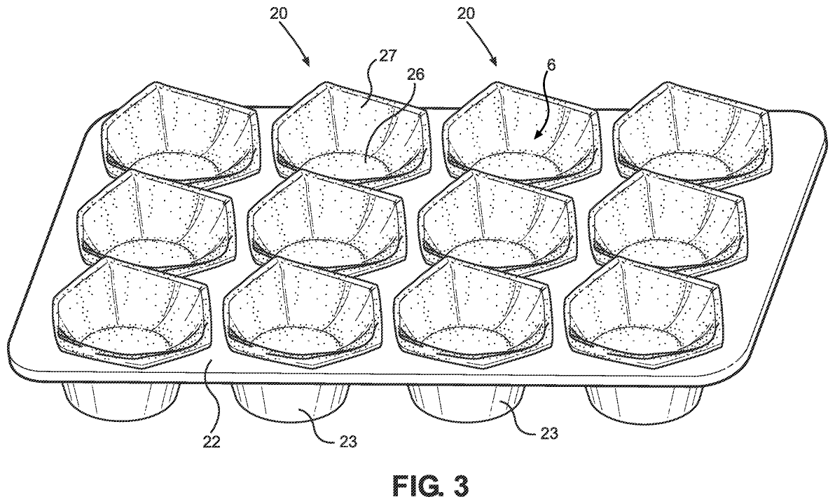

FIGS. 2 and 3 show preferred uses of dividable dough sheet piece 1 and its sub-pieces 6, where dough sheet piece 1 is made from dough suitable for making pie crust. If dough sheet piece 1 is provided in a packaged form, such as in a cylindrical tube package, dough sheet piece 1 is first unpackaged and, if in rolled form, unrolled to prepare dough sheet piece 1 for use by the consumer. In FIG. 2, a pie crust 12 is prepared by placing dough sheet piece 1 (unpackaged and unrolled), with its sub-pieces 6 and trimmings 8 intact, into a pie pan 14. Preferably, dough sheet piece 1 is pressed against the side and bottom of pie pan 14 to form a side 15 and a bottom 16 of pie crust 12. Further, dough sheet piece 1 is crimped along perimeter 2 to form a crimped edge 17. Optionally, dough sheet piece 1 may be trimmed along perimeter 2 before crimped edge 17 is formed. Depending on the recipe used by the consumer, pie crust 12 may or may not be baked after it is formed in pie pan 14 and before it is filled with pie filling (e.g., pudding, pecan, pumpkin, quiche, etc.) (not shown), whereupon the lines of structural weakness 3 are lost due to expansion and joining of the dough across the openings or recesses upon being heated. Although illustrated in FIG. 2 in connection with establishing a pie crust, in other embodiments, intact dough sheet piece 1 may be used for other purposes. For example, if dough sheet piece 1 were made of dough suitable for making pizza crust, intact dough sheet piece 1 may be used in order to prepare a pizza crust.

In FIG. 3, after dough sheet piece 1 is unpackaged and unrolled, a consumer prepares individual or mini-pie crusts 20 by separating sub-pieces 6 from dividable dough sheet piece 1 along the lines of structural weakness 3 and individually placing sub-pieces 6 into cups 23 of a muffin pan 22. Preferably, each sub-piece 6 is pressed or otherwise shaped into the side and bottom of cup 23 to create a bottom 26 and an annular side 27 of mini-pie crust 20. Optionally, each sub-piece 6 may be trimmed before or after they are placed into cups 23. As mentioned above, lines of structural weakness 3 provide pre-determined breaking points within dough sheet piece 1 to facilitate the separation of sub-pieces 6 from dough sheet piece 1. One or more sub-pieces 6 are separated as needed from dough sheet piece 1 along the respective one or more lines of structural weakness 3 that outline the desired sub-piece 6. Similar to pie crust 12, depending on the recipe used by the consumer, mini-pie crusts 20 may or may not be baked after they are formed and before they are filled with pie filling (e.g., pudding, pecan, pumpkin, quiche, etc.) (not shown). Although shown in FIG. 3 for the purpose of preparing mini-pie crusts, in other embodiments, one or more sub-pieces 6 may be separated from dough sheet piece 1 and used for other purposes. For example, if dough sheet piece 1 were made of dough suitable for making pizza crust, one or more sub-pieces 6 may be separated as needed from dough sheet piece 1 along the respective one or more lines of structural weakness 3 in order to prepare mini-pizza crusts.

In FIG. 4 there is shown a portion of an exemplary production line for producing sheeted dough pieces 1 in accordance with the present invention. Specifically, FIG. 4 shows a dough sheet 30 being transported in a direction 33 by a conveyor system 35. In the embodiment illustrated, conveyor system 35 includes a conveyor belt 36 on which dough sheet 30 is supported. However, other conveyor systems known in the art can be used with the present invention.

Again, dough sheet 30 is preferably made from a dough suitable for making a pie crust or a pizza crust. However, other doughs, such as doughs for other refrigerated dough products, can be used to make dough sheet 30. Also preferably, dough sheet 30 is made using wheat flour. However, dough sheet 30 can be made using one or more types of known flours (e.g., gluten-free flour), as desired. Further, it should be recognized that the width of dough sheet 30 can vary.

Dough sheet 30 passes beneath a rotary cutter 40, which is configured to repeatedly cut dough pieces 1 from dough sheet 30 as dough sheet 30 is transported in direction 33. For example, FIG. 4 shows successively cut dough pieces 1. Rotary cutter 40 is supported above dough sheet 30 by supports 42 and 43. Supports 42 and 43 are located on opposite sides of conveyor belt 36, with rotary cutter 40 extending between supports 42 and 43 such that rotary cutter 40 is arranged to rotate about an axis extending perpendicular to direction 33.

Rotary cutter 40 is configured such that contact between rotary cutter 40 and dough sheet 30 or conveyor belt 36 causes rotary cutter 40 to rotate in a direction 45 as dough sheet 30 and conveyor belt 36 travel in direction 33. Alternatively, a motor and transmission (collectively labeled 48) can be provided for causing rotary cutter 40 to be positively driven to rotate in direction 45. In either case, each full rotation of rotary cutter 40 results in one dough piece 1 being cut from dough sheet 30. Although not mandatory, it has been found beneficial from a strength standpoint to arrange rotary cutter 40 as depicted such that a leading edge of the first dough sub-piece 6 in the direction of travel is a flat edge 3 (generally perpendicular to the direction of travel) versus having a point or area between adjacent dough pieces leading.

At this point, it should be understood that the terms “polygonal”, “hexagonal”, “elliptical”, “circular”, “circle”, “oval”, “hexagon”, “polygon” or the like confer general geometric shapes only in accordance with the invention. By way of example, stating that each sub-piece 6 has the shape of a hexagon does not mean that each peripheral section is perfectly straight or that each section has the same exact wall dimensions. In fact, since dough sheet 30 is under some tension as it moves along conveyor 36, there will inherently be some initial expansion or stretching of the dough, followed by a contraction after each dough piece 1 is formed. Therefore, somewhat “elongated” hexagons can be establish in an oval or elliptical dough piece 1, with the knowledge that the cut dough piece 1 will contract, resulting in a final product which will be closer to circular overall, along with dough sub-pieces 6 which are closer to hexagonal overall. Preferably the ratio of the dimension of dough piece 1 in the direction of travel to the dimension of dough piece 1 perpendicular to the direction of travel will actually be in the range of about 1.00-1.20, depending on sheeting line operational parameters and dough formulation, while still resulting in a final, generally circular dough piece 1. Certainly, employing such elongated cutting dimensions in making circular pie crusts is known in the art, with the invention adapting this concept, by extension, for use in connection with forming dough sub-pieces 6. In any case, dough sheet 30 with various dough pieces 1 cut therein is further processed and dough pieces 1 are packaged. For example, dough pieces 1 are separated from dough sheet 30 and are rolled (e.g., individually or in stacked pairs) and placed in packages (e.g., spiral-wound cylinder) in rolled form. However, alternative or additional processing and packaging can be employed after dough pieces 1 are cut from dough sheet 30, depending on the manufacturer's needs.

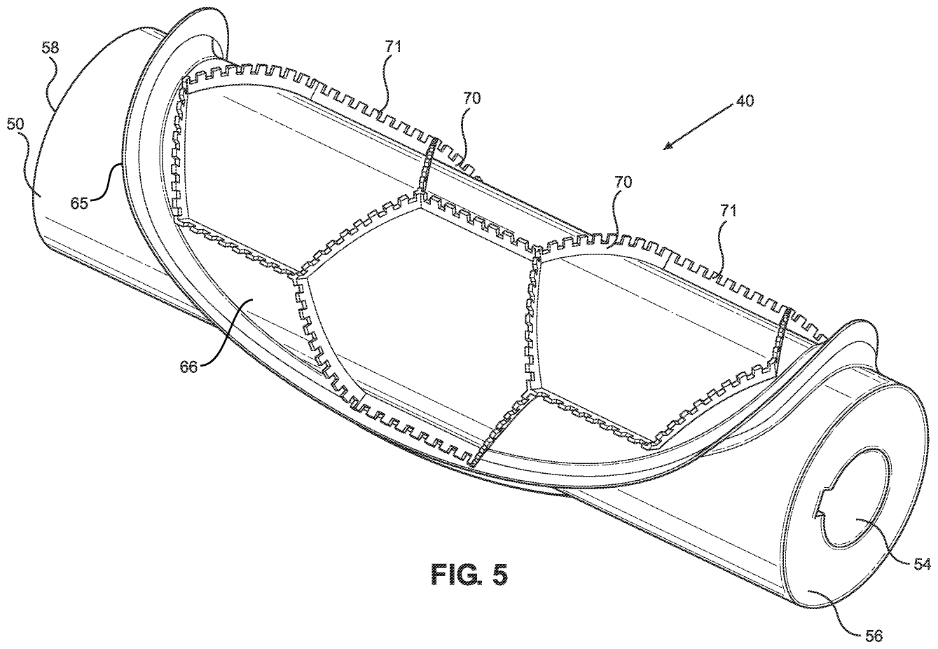

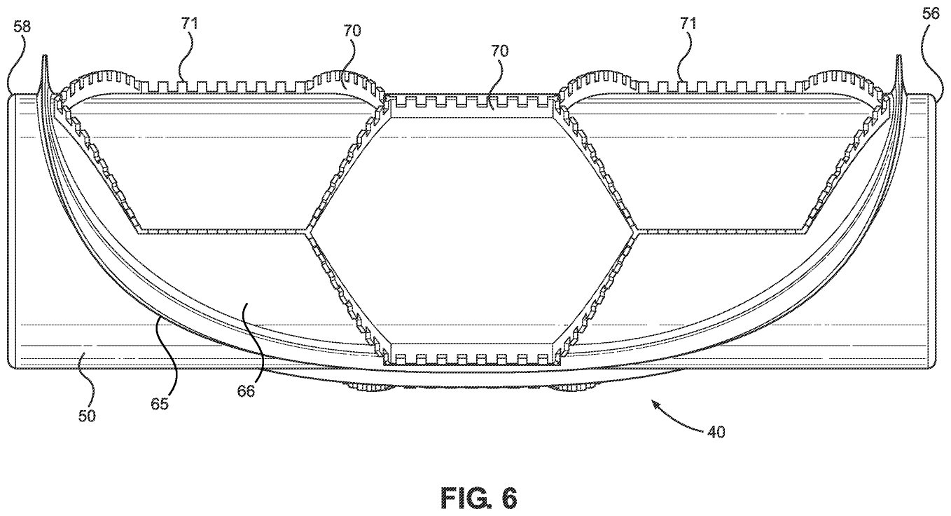

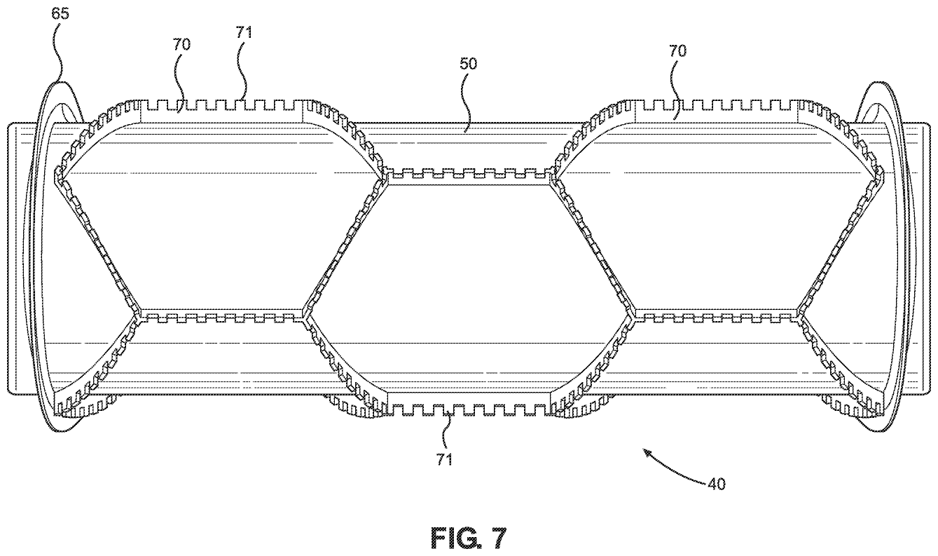

FIGS. 5-7 shows an exemplary embodiment of rotary cutter 40 in more detail. Rotary cutter 40 includes a shaft or central body 50 having holes 54 located at opposite ends 56 of shaft 50. In particular, shaft 50 has a first end hole 54, located at a first end 56 of shaft 50, that extends through shaft 50 in the longitudinal direction to establish a second end hole (not visible) at a second end 58 of shaft 50. Each of supports 42 and 43 includes a rod or other protrusion (not shown) that is configured to fit within hole 54 to enable rotary cutter 40 to rotate relative to supports 42 and 43. In connection with the motor driven embodiment mentioned above, a drive rod can both extend through and be keyed (note key slot shown for through hole 54 but not labeled) to shaft 50, thereby positively coupling shaft 50 to motor and transmission 48. Of course, other coupling mechanisms known in the art can be used to couple rotary cutter 40 while enabling rotation of shaft 50.

Rotary cutter 40 further includes a plurality of blades 65 and 70 extending radially outward from shaft 50 and being curved around the circumference of shaft 50. More specifically, an outer peripheral blade 65 defines and encloses an interior area 66. Inner blades 70 are located in interior area 66. Outer blade 65 is configured to cut dough pieces (e.g., dough pieces 1) from dough sheet 30. In other words, the location of the cut performed by outer blade 65 in dough sheet 30 corresponds to the outer perimeter of the resulting dough piece 1 (e.g., outer perimeter 2). As shown, outer blade 65 is shaped so as to cut an oval dough piece. However, in other embodiments, outer blade 65 can be shaped to cut non-oval dough pieces (e.g., circular pieces).

In the embodiment shown, each of inner blades 70 includes a plurality of spaced teeth 71. Teeth 71 are configured to create lines of structural weakness 3 within dividable dough sheet piece 1. In particular, teeth 71 perforate dough sheet pieces 1 at the same time that dough sheet pieces 1 are being cut from dough sheet 30 by outer blade 65. Teeth 71 can also be used to make score lines, and contiguous cutting edges could be employed for this purpose. Again, for purposes of the invention, score lines are cuts in the surface of the dough sheet piece 1 and do not extend completely through the dough sheet piece 1. Score lines may be continuous or broken (i.e., a series of disconnected cut segments). Contrasted with score lines, perforations extend through the dough sheet piece. Preferably, if teeth 71 are to form lines of structural weakness 3 that include perforations, the perforations are formed as a series of disconnected perforations that create a narrow web of dough between sub-pieces 6. Teeth 71 shown in FIGS. 4-7 have square dimensions. However, other proportions for teeth 71 can be readily employed to create lines of structural weakness 3 in accordance with the present invention. As previously mentioned, lines of structural weakness 3 facilitate separation of sub-pieces 6 from dough sheet 1.

In the embodiment of FIGS. 4-7, inner blades 70 of rotary cutter 40 are arranged to form seven tessellated hexagon shapes (resembling a honeycomb structure). That is, in use, the exemplified arrangement of inner blades 70 create lines of weakness 3 in each dividable dough sheet piece 1 that define seven substantially hexagonal sub-pieces 6. In particular, such an arrangement leaves no interior trimmings in between sub-pieces 6 (corresponding to dough sheet piece 1 of FIG. 1 which has no interior trimmings in between adjacent sub-pieces 6). However, inner blades 70 can be arranged to create lines 3 that define other shapes (e.g., circular) for the sub-pieces or create a number of sub-pieces other than seven in accordance with the present invention. Preferably, inner blades 70 are arranged to create lines 3 that define each sub-piece 6 as a polygon and are arranged to create sub-pieces 6 which are tessellated to minimize gaps therebetween. However, depending upon the manufacturer's needs, inner blades 70 can be arranged to create sub-pieces 6 having trimmings 8 therebetween as discussed above.

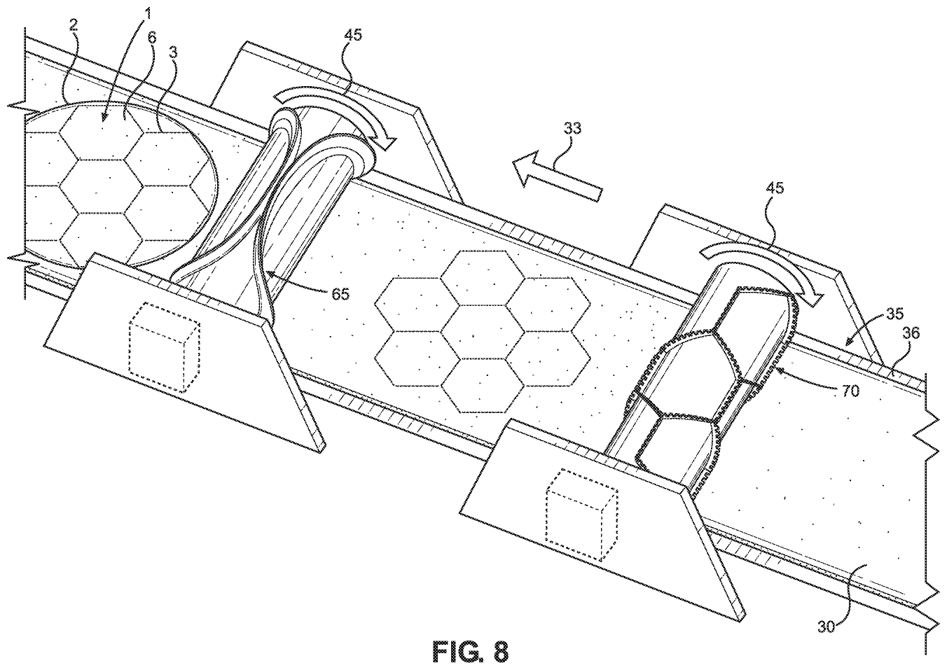

Based on the above, it should be readily apparent that the present invention provides a dough sheet piece that provides consumers with the option of easily separating therefrom dough sub-pieces depending on the consumer's desired end product, as well as an apparatus and method for producing the dough sheet piece and method for using the dough sheet piece. While certain preferred embodiments of the present invention have been set forth, it should be understood that various changes or modifications could be made without departing from the spirit of the present invention. For example, the functions performed by inner and outer blades 65 and 70 need not be performed simultaneously as in the embodiment described above. Instead, these operations could be performed sequentially, such as with one cutting or forming unit located downstream of another cutting or forming unit along the conveyor. One potential alternative embodiment along these lines is represented in FIG. 8 (note certain common reference numerals from FIG. 4 being brought forward) wherein the forming unit with blade 65 is located downstream of the forming unit with blades 70. Of course, this sequential arrangement could also be reversed wherein blade 65 is upstream of blades 70. In an even different configuration, the operation(s) performed by one or more of the rotary dividable dough piece forming units could be done using one or more vertical operating cutting and/or scoring/perforating units, e.g., a single stamping unit or upstream/downstream stamping units. Furthermore, it should be recognized that the invention can be carried out using either sharp or blunt-edge cutters known in the art. In general, the invention is only intended to be limited by the scope of the following claims.

1. A dividable dough sheet piece comprising a dough sheet piece cut from a dough sheet and being defined by a perimeter, the dough sheet piece including a plurality of sub-pieces within the perimeter, each sub-piece being defined by one or more lines of structural weakness.

2. The dividable dough sheet piece of claim 1, wherein the perimeter is in the shape of a non-polygon.

3. The dividable dough sheet piece of claim 2, wherein the perimeter is in the shape of a circle or oval.

4. The dividable dough sheet piece of claim 1, wherein each sub-piece is substantially polygonal in shape.

5. The dividable dough sheet piece of claim 4, wherein each sub-piece is a hexagon.

6. The dividable dough sheet piece of claim 1, wherein the plurality of sub-pieces comprises more than 70% of the dividable dough sheet piece.

7. The dividable dough sheet piece of claim 1, wherein the lines of structural weakness are constituted by score lines or perforations.

8. A method of producing a dividable dough sheet piece comprising:
directing a sheet of dough along a conveyor; and
both cutting and scoring or perforating the dough to create a dough sheet piece defined by a perimeter along with lines of structural weakness within the perimeter of the dough sheet piece, where the lines of structural weakness define a plurality of sub-pieces within the perimeter of the dough sheet piece.

9. The method of claim 8, wherein the perimeter is in the shape of a non-polygon.

10. The method of claim 9, wherein the perimeter is in the shape of a circle or oval.

11. The method of claim 8, wherein each sub-piece is substantially polygonal in shape.

12. The method of claim 8, wherein each sub-piece is a hexagon.

13. The method of claim 8, wherein the plurality of sub-pieces comprises at least 70% of the dough sheet piece.

14. The method of claim 8, wherein the dough sheet is cut by an outer blade of a rotary cutter, with the outer blade extending radially outward from a shaft, and the lines of structural weakness are created by a plurality of inner blades extending from the shaft within the outer blade, wherein the dough sheet is simultaneously cut and scored or perforated.

15. The method of claim 8, wherein cutting of the dough is performed either upstream or downstream of the scoring or perforating of the dough.

16. The method of claim 8, further comprising packaging the dividable dough sheet in a package with the dough sheet piece being already scored or perforated to establish the plurality of sub-pieces.

17. A method of using a dividable dough sheet piece defined by a perimeter and including a plurality of sub-pieces defined by one or more lines of structural weakness within the perimeter comprising:
when being used in making a pie, employing the entire dividable dough sheet piece as a crust for the pie; and
when being used in making one or more mini-pies, separating one or more of the sub-pieces from a remainder of the dividable dough sheet piece along the one or more lines of structural weakness and employing each of the one or more of the sub-pieces as a crust for a mini-pie.

18. The method of claim 17, further comprising, when using the dividable dough sheet piece in making a pie, shaping the entire dividable dough sheet piece to a pie pan.

19. The method of claim 17, further comprising, when using the one or more of the sub-pieces as the crust for a mini-pie, shaping the one or more of the sub-piece within a muffin pan.

20. The method of claim 17, further comprising, removing the dividable dough sheet piece from a package with the dough sheet piece being already scored or perforated to establish the one or more lines of structural weakness that define the plurality of sub-pieces.
